(19) United States
(12) Patent Application Publication
(10) Pub. No.: US 2007/0026366 A1
(43) Pub. Date: Feb. 1, 2007

(54) Talking leaves

(76) Inventors: Ewa Visconti, El Cajon, CA (US); Eric Visconti, El Cajon, CA (US)

Correspondence Address: Eric Visconti, 1377 Oakdale Ave # 3, El Cajon, CA, 92021, US

(21) Appl. No.: 11/191,214

(22) Filed: Jul. 28, 2005

(51) Int. Cl. G09B 1/00; G09B 19/00

(52) U.S. Cl. 434/167; 434/236

(57) ABSTRACT

Our daughter has been affected since birth by a genetic disease that caused deformities in the speech center of her brain, and has caused her to have autistic traits. As we have searched for various help and therapy to assist our daughter in learning to speak, we have noticed how she was stimulated by familiar faces and places. Her stimulation could easily be seen as she would scroll happily through our family's digital photo collection on our computer. My wife Ewa then decided to take photos of jessica's classmates and friends, and asked me to help her create simple descriptive sentences of the actions in the photographs. What we have created are sets of laminated photo cards with Velcro fasteners. Jessica's task has been to attempt to read the sentences, and match the correct sentence to the correct photo and fasten them together with Velcro. This was accomplished with visual pointing to associate the objects of interest in the photos, with their corresponding letter patterns or words. I would then speak to tie the idea with a spoken word label, while pointing to the written word. A few words could soon be recognized. I helped her to learn how to sound out words she could not recognize. Within a few cycles of the first card set, Jessica's skills developed rapidly. When we set out the next created card set, Jessica demanded to try by her self and was reading a remarkable number of cards without difficulty.

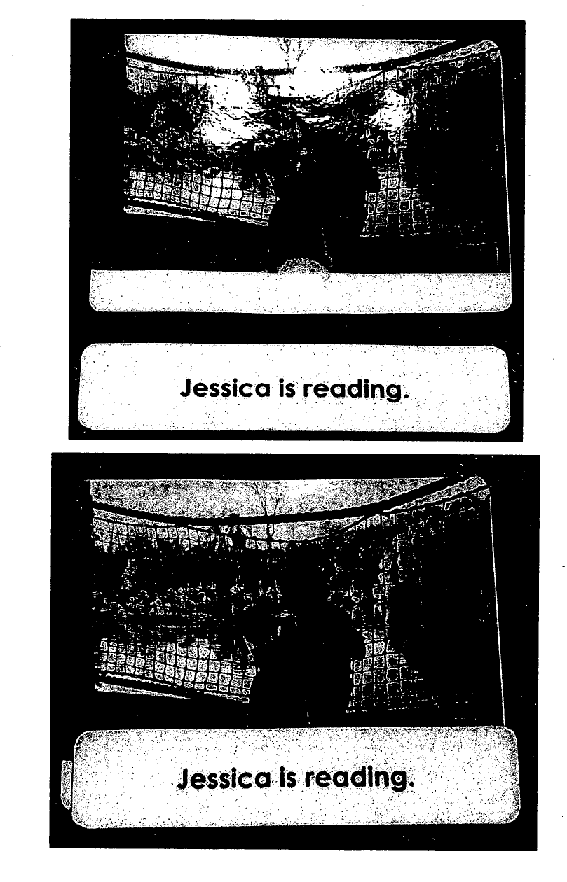

### SKILLS USED AND ENHANCED

Matching—Words to pictures. Children will love seeing how letter combinations (words) correspond to physical objects in the pictures.
Association—Children will learn how thoughts and words relate by using the pictures and their corresponding text labels of items, actions, or concepts.
Memorization—Children will retain what they have seen in words relating to the physical world and build this knowledge with every repetition of the cards.
Pronunciation—A difficult area, yet progress will be made as the visual objects, text labels, and verbal labels come to a sensible relation within their minds.

### MAIN BENEFIT

Speech will be offered, taught and learned by approaching the children in their own comfortable zone of living and learning by pattern association.

### PROCESS

We will create a set of cards from our own basic source of photos. Best results may be achieved when a parent or school teacher can send us a CD of photographs containing people and places that the child is familiar with. The familiarity will heighten stimulation to talk, as it has with our daughter.

As a beginning stage for other children, we can create sets of cards with single noun words or verbs as it may be necessary to build a simple foundational understanding before proceeding further. A successful conclusion of this stage would be when the child autonomously makes one word requests on his or her own.

The stage where we began with our daughter was with sentence use. We would take photographs, and create photo cards with simple sentences that would attach with Velcro.

The goal here is to go from one word requests like “water”, to sentence requests like “I would like a drink of water, please.” The goal is also for the child to have enough understanding of sentence use to ask, “Are you alright?” when someone would appear to be hurt. We have seen our daughter enter this interaction phase, and she is still progressing.

On page 8 is an example of a Talking Leaves card.

### PROCEDURAL GUIDELINE

I. We would create cards, ideally with images the child is familiar with, and send them to the client. Upon receipt of the cards, the parent or teacher would sit down with the child and teach in the following matter.
1). Go through the pictures with the sentences correctly attached, and read each sentence slowly.
2). Speak the same sentence again slowly, pointing out objects in the photo with their correct verbal labels.
II. After doing this a few times, the second stage would be to give the cards to the child and help that child to speak the words while pointing them out on the text attachments.
III. The third stage will be to detach the sentences from the pictures and allow the child to match them correctly.
1). Hand each sentence to the child with the photos arranged on the floor or table.
2). Help the child properly pronounce and read the words, assisting by sounding difficult words where necessary.
3). Reward the child by allowing him/her to match the sentence with the correct photo.
4). Applaud and show enthusiasm in the child's accomplishments!

1. What we claim as our invention is a new system of teaching vocabulary and word usage to children who are impaired with developmental and neurological speech disorders. This system will use a common denominator of intense pattern orientation in these children. As these children are drawn to patterns, and create patterns where none exist; this system will guide them into a pattern where they can autonomously organize their thoughts with verbal and text labels they were not able to take hold of before.
